(19) United States
(12) Patent Application Publication
(10) Pub. No.: US 2016/0163008 A1
(43) Pub. Date: Jun. 9, 2016

(54) SYSTEM FOR THE ACCURACY OF INFORMATION RELATED TO STUDYING ABROAD

(71) Applicants: In-Suk KIM, Seoul (KR); UNITED UNIVERSITY AND COLLEGE ASSOCIATION IN KOREA, Seoul (KR)

(72) Inventor: In-Suk KIM, Seoul (KR)

(73) Assignees: UNITED UNIVERSITY AND COLLEGE ASSOCIATION IN KOREA, Seoul (KR); In-Suk KIM, Seoul (KR)

(21) Appl. No.: 14/562,545

(22) Filed: Dec. 5, 2014

(51) Int. Cl. G06Q 50/20; G06Q 10/00

(52) U.S. Cl. CPC G06Q 50/2053; G06Q 10/00

(57) ABSTRACT

A system for ensuring the accuracy of information related to studying abroad of international students includes: a study-abroad candidate terminal that enables a study abroad candidate to proceed with a process to sign up for a membership by accessing the internet and to provide his or her own information necessary for studying abroad or receive external information on studying abroad online; an operating association server that is operated by an operating association in the study-abroad candidate's native land corresponding to an association for generally operating the procedure for studying abroad of the study abroad candidate; an affiliated office server that is operated and managed by an institution for studying abroad determined by the study-abroad candidate as the institution targeted for studying abroad; and a relevant institution server that is linked with the affiliated office server and is operated by the institution for studying abroad targeted by the study-abroad candidate.

### BACKGROUND OF THE INVENTION

1. Field of the Invention

The present invention generally relates to a system for ensuring the accuracy of information related to studying abroad for international students. More particularly, it relates to a system for ensuring the accuracy of information related to studying abroad for international students that manages all matters pertaining to the procedures for studying abroad between a student studying abroad and a local institution (elementary school/middle school/high school/university or the like) and proceeds with the procedures for studying aboard on the assumption that all matters pertaining to the relevant studying abroad performed via consultative procedures between the student studying abroad and an operating institution or a relevant institution (studying abroad section) are legally ensured.

2 . Description of the Related Art

Recently, in an effort to meet the demands of globalization, there has been a steady increase in the number of students going abroad for primary school, language training, or intensive professional education.

In order go abroad for study or language training, an interested person had to directly go through bothersome processes such as searching for information and procedures for studying abroad, selecting a country, a region, selecting a school, etc.

In order to solve this problem, many agencies that help place students in overseas schools have been established and operated. These agencies provide a student who wants to study abroad with information on a target country offline and transmit personal information of the interested party online to an agency in the target country. Furthermore, the agencies receive an acceptance letter on behalf of the student from the foreign school when the student determines to go study abroad, thereby arranging suitable homestay for the student who will study abroad.

These agencies, which are currently widely operated, attract candidates for studying abroad and provide these candidates with various kinds of information about schools, local life, culture, environment and the like necessary for studying abroad. Based on the information, the candidates determine whether or not to study abroad.

The international students are people in different age groups and range from elementary school students to university students. These international students are faced with many problems of life in a foreign country resulting from living in the foreign country separated from their parents. For example, international students and parents thereof have great concerns about learning efficiency and stability of their child, including concerns about learning styles, food, sleeping arrangements and so on. Even though study abroad agencies have provided school information and information on living conditions for foreign students, based on merely the information, it is difficult for international students to achieve the systematic life of studying abroad.

Due to this problem regarding studying abroad, some candidates for studying abroad or parents thereof abandon going overseas to study or return from studying abroad. This is a problem for overseas study agencies, and solution thereof is required.

Meanwhile, the number of Korean international students has been gradually increasing, and as a result, a relevant market has been also vitalized. However, various problems resulting from the vitalization of the market have been generated. That is, payment refunds are not properly performed during the handling of expenses between the agencies and international students or the overseas environment is quite different from what was explained by the agency. Thus, disputes have been gradually increasing. However, since there were neither solution plans therefor nor institutions of management and supervision, prior dispute prevention could not be expected.

Thus, despite the fact that wasted time, mental anxiety and economic loss have been experienced by international students and parents thereof studying, there are no national-level solution plans implemented to prevent such issues.

The procedure for studying abroad has been performed by agencies that help place students in overseas schools, and is frequently done so in consideration of a high commission rather than various other conditions for students' convenience. Thus, in spite of the gradually increasing number of candidates for studying abroad and the high cost services provided by the study abroad agencies, disputes have been generated due to the overseas conditions (school, lodging and the like) being different from those explained by the study abroad agencies upon entering into a contact because students or their parents could not have clear information until they visit a target foreign institution. In spite of this fact, the procedure for studying abroad has been handled in a state where the scope of responsibility about the disputes and study abroad-related conditions are unclear. It is difficult for international students to bear all the responsibility by themselves and to achieve academic performance due to the goals of the study abroad agencies superseding the goals of the student during the selection of a school or university even though the student selects a proper school or university and complete his or her study.

In a state where an opportunity to understand school life adaption or a cultural difference in school or general life is lacking, since the procedure service for studying abroad for international students has been performed in view of business profits of the agencies, the international students cannot adjust to life abroad due to the lack of understanding of foreign school life, cultural differences and the like and thus experience many disadvantages. Thus, the development of a program for studying abroad to overcome these problems has been urgently needed. In spite of this fact, the government's policy on studying abroad has caused a reduction of financial values disbursed for studying abroad, thereby leading to deprivation of economical values of the international students.

First, with regard to the procedure for studying abroad, candidates for studying abroad have the actual inconvenience that they cannot accurately know conditions of the target area unless they visit an institution located in the target country, thus they are dependent on the information strength of the agencies.

Second, with regard to the selection of a university upon studying abroad, it is difficult to compare and analyze various kinds of information about universities during selecting general matters related with studying abroad unless the procedure mentioned above is improved, and as a result, it is problematic in that an appropriate selection cannot be performed.

### SUMMARY OF THE INVENTION

Accordingly, the present invention has been made keeping in mind the above problems occurring in the related art, and an object of the present invention is to provide a system that can perform all general matters pertaining to the procedure for studying abroad, such as detailed information about local institutions supporting study abroad, an agreement of study abroad-related matters, an application for admission and the like by establishing a database (an operation server) in the country (e.g., Republic of Korea) in order to solve environmental and marginal difficulty of the study abroad-market resulting from the currently universalized condition of studying abroad in which an opinion gap between a candidate for studying abroad and a foreign university is based on the requirements of entrance examination (the standards for the selection of new students) of the foreign university.

Another object of the present invention is to provide a system for ensuring the accuracy of information related to studying abroad that can prevent the rights and interests of candidates for studying abroad in advance from being abandoned or damaged and can stably ensure all matters pertaining to the procedure for studying abroad by obtaining legal basis materials.

In order to achieve the above objects, according to one aspect of the present invention, there is provided a system for ensuring the accuracy of information related to studying abroad of international students, including: a study-abroad candidate terminal that enables a study abroad candidate to proceed with a process to sign up for a membership by accessing to the internet network and to provide his or her own information necessary for studying abroad or to receive external information on studying abroad online so that the candidate can ask for admission or can determine whether or not to study abroad; an operating association server that is operated by an operating association in the study abroad candidate's native land corresponding to an association for generally operating the procedure for studying abroad of the study abroad candidate, wherein the operating association server receives member information provided via the study-abroad candidate terminal for enabling the candidate to perform the process to sign up for a membership and requests official information necessary for studying abroad and also receives the corresponding official information; an affiliated office server that is operated and managed by an institution for studying abroad determined by the study-abroad candidate as the institution targeted for studying abroad, wherein the affiliated office server provides the operating association server with information necessary for the procedure for studying abroad received from the corresponding institution, enables a database to be shared so that the information can be provided to the study-abroad candidate who requests the admission for studying abroad, and receives official information on the procedures for studying abroad of the study-abroad candidate provided from the operating association server; and a relevant institution server that is linked with the affiliated office server and is operated by the institution for studying abroad in the foreign country targeted by the study-abroad candidate, wherein the relevant institution server provides the affiliated office server with all official information pertaining to the procedures for studying abroad and finally receives and manages all official information pertaining to studying abroad provided with the study-abroad candidate. Here, the operating association server may provide the study abroad candidate terminal with the form of a certificate of ensuring the accuracy of information related to studying abroad to receive a draft certificate of ensuring the accuracy of information related to study abroad from the study abroad candidate. Furthermore, the operating association server, which has received the draft certificate, may determine as to whether or not to agree to the draft certificate by receiving a compromise for the draft certificate from the affiliated office server and issues qualification codes for enabling accessing to a certification module provided via online and for validating the final certificate of ensuring the accuracy of information related to studying abroad that has been finally determined through the agreement. Thus, the respective qualification codes can be allocated to the study-abroad candidate terminal, and the study abroad candidate, the association and the university can simultaneously perform digital signatures via the study-abroad candidate terminal, the operating association server and the affiliated office server in a state of being simultaneously connected to the certification module via the respective qualification codes, thereby proceeding with approval of the procedure for studying abroad.

Also, the study-abroad candidate terminal may enable the study abroad candidate to perform a process for signing up for a membership of the association when the candidate is not registered in the operating association server as a member.

Also, the affiliated office server may request the operating association server to perform a request for the verification of qualification so that the study abroad candidate can obtain the verification of qualification, and official affaires for studying abroad can be performed upon completing of the verification of qualification via the affiliated office server.

Also, the certificate of ensuring the accuracy of information related to studying abroad may include all kinds of information about studying abroad and may be intended to ensure study abroad-related matters including a curriculum for learning, a living condition (dormitory, lease or the like), living information of students and so on.

Also, the affiliated office server may share a database by being linked with the relevant institution server, wherein the affiliated office server provides the operating association server with information about requirements for entrance examination that will be basically provided to the study abroad candidate and also provides the information about the requirements for entrance examination when the study abroad candidate performs a search for study abroad-related information by accessing to the study-abroad candidate terminal.

Also, the operating association server may issue a membership code for the affiliated office when a request for membership qualification is received from the affiliated office server and the affiliated office is determined as a member.

Also, the operating association server may issue the final certificate of ensuring the accuracy of information related to studying abroad with the digital signatures when the digital signatures performed via the study-abroad candidate terminal, the operating association server and the affiliated office server are completed, and may store the contents of the certificate in an operating association database, thereby transmitting the certificate to the study abroad candidate via e-mail.

Also, the operating association server may include an operating association database in which information about the study abroad candidate registered as a member via the study-abroad candidate terminal and information about the institution for studying abroad registered a member via the affiliated office server are stored.

Also, the affiliated office server may further include an affiliated office database in which the certificate of ensuring the accuracy of information related to studying abroad of the corresponding study abroad candidate issued by the digital signatures of the system for ensuring the accuracy of information related to studying abroad via the study-abroad candidate terminal, the operating association server, and the affiliated office server, and information about the study abroad candidate received from the operating association server are stored, and which is provided to the relevant institution server.

The present invention configured and operated as described above is advantageous in that in selecting study abroad-related matters, the study abroad candidate can be provided with information about study abroad-related general procedures including entrance formalities by operating the server of the affiliated office established via local incorporation of the relevant institution for studying abroad and sharing the study abroad-related general matters with the operating association server via linkage with the relevant institution server, and the student can more easily adjust to life overseas and stability of the study abroad candidate can be ensured because the study abroad-related matters of the study abroad candidate are finally determined under an agreement via the certificate of ensuring the accuracy of information related to studying abroad rendered by the study abroad candidate, the operating association and the affiliated office

Also, the present invention is characterized in that the candidates for studying abroad can be provided with detailed and systematic information about studying abroad provided via the affiliated office server, and this structure can maximize a marketing effect of the institution in view of attracting international students.

Consequently, the present invention is advantageous in that the procedures after the derivation and decision of a consensus between study abroad-related parties (i.e., a candidate for studying abroad and an institution for studying abroad are reasonably and clearly provided so that problems generated from the structures of existing study abroad agencies that help place students in overseas schools can be completely solved, thereby largely contributing to the advancement of the relevant business world.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a schematic block diagram of a system for ensuring the accuracy of information related to studying abroad according to the present invention;

FIG. 2 is a flow chart schematically explaining the procedure for ensuring the accuracy of all matters pertaining to study abroad of the system a system for ensuring the accuracy of information related to studying abroad according to the present invention;

FIG. 3 is a detailed diagram for explaining an initial cooperation process of the system for ensuring the accuracy of information related to studying abroad according to the present invention;

FIG. 4 is a diagram for showing a digital signature process for ensuring the accuracy of matters pertaining to study abroad with regard to the system for ensuring the accuracy of information related to studying abroad of international students according to the present invention; and

FIG. 5 is a block diagram showing an operational status of a module system for ensuring the accuracy of information related to studying abroad according to the present invention which is intended for an electronic signature.

### DETAILED DESCRIPTION OF THE INVENTION

Hereinbelow, embodiments of a system for ensuring the accuracy of information related to studying abroad of international students according to the present invention will be described in detail with reference to the accompanying drawings.

A system for ensuring the accuracy of information related to studying abroad of international students according to the present invention includes: a study-abroad candidate terminal 100 that enables a study abroad candidate to proceed with a process to sign up for membership by accessing the internet and to providing information necessary for studying abroad or to receive external information on studying abroad online so that the candidate can ask for admission or can determine whether or not to studying abroad; an operating association server 200 that is operated by an operating association in the study-abroad candidate's native land corresponding to an association for generally operating the procedure for studying abroad of the study abroad candidate, wherein the operating association server receives member information provided via the study-abroad candidate terminal for enabling the candidate to perform the process of signing up for membership and requests official information necessary for studying abroad and also receives the corresponding official information; an affiliated office server 300 that is operated and managed by an institution for studying abroad in a foreign country determined by the study-abroad candidate as the institution targeted for studying abroad, wherein the affiliated office server provides the operating association server with information necessary for the procedure for studying abroad received from the corresponding institution, enables a database to be shared so that the information can be provided to the study-abroad candidate who requests admission for studying abroad, and receives official information on the procedures for studying abroad of the study-abroad candidate provided from the operating association server; and a relevant institution server 400 that is linked with the affiliated office server and is operated by the institution for studying abroad in the foreign country targeted by the study-abroad candidate, wherein the relevant institution server provides the affiliated office server with all official information pertaining to the procedures for studying abroad and finally receives and manages all official information pertaining to studying abroad provided with the study-abroad candidate, wherein the operating association server provides the study-abroad candidate terminal with the form of a certificate of ensuring the accuracy of information related to studying abroad to receive a draft certificate of ensuring the accuracy of information related to study abroad from the study abroad candidate, and wherein the operating association server, which has received the draft certificate, determines as to whether or not to agree to the draft certificate by receiving a compromise for the draft certificate from the affiliated office server and issues qualification codes for enabling accessing to a certification module provided via online and for validating the final certificate of ensuring the accuracy of information related to studying abroad which has been finally determined through the agreement, whereby the respective qualification codes can be allocated to the study-abroad candidate terminal, and the study abroad candidate, the association and the university can simultaneously perform digital signatures via the study-abroad candidate terminal, the operating association server and the affiliated office server in a state of being simultaneously connected to the certification module via the respective qualification codes, thereby proceeding with approval of the procedure for studying abroad.

The technical gist of the system for ensuring the accuracy of information related to studying abroad of international students according to the present invention is that all general matters resulting from an application for admission between a candidate for studying abroad and an institution for studying abroad (e.g., university and so on) and pertaining to the life of studying abroad are finally determined by agreement between the both parties and digital signatures for a certificate of ensuring the accuracy of all the general matters are performed, so that unreasonable situations can be prevented from being generated during the local life of studying abroad by a clear and accurate request for studying abroad and receipt thereof based on contractual rationalization, a reliability-based transaction, legal basic data and the like.

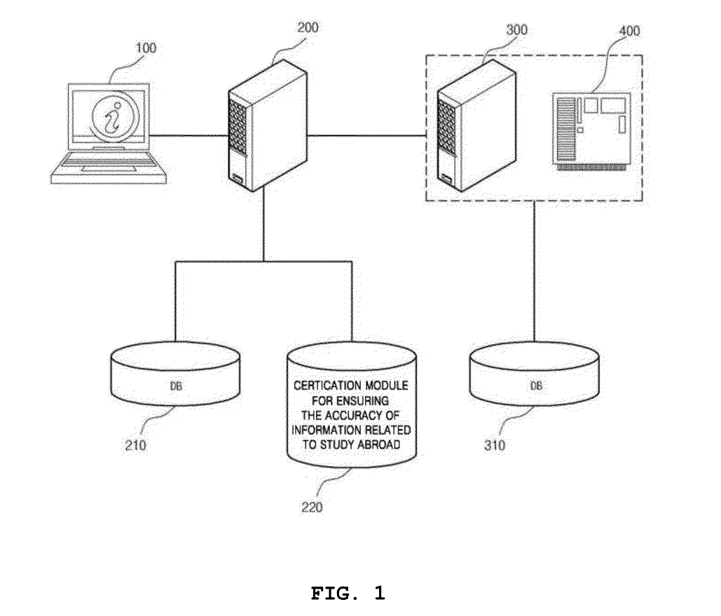

FIG. 1 is a schematic block diagram of a system for ensuring the accuracy of information related to studying abroad according to the present invention;

As illustrated in FIG. 1, the system for ensuring the accuracy of information related to studying abroad for international students includes: the study abroad candidate terminal 100 that enables the study abroad candidate to search or request information about studying abroad through on-line connection, to join as a member, to log on, to render a final decision, and to write his or her signature and the like; the operating association server 200 that generally operates the system for ensuring the accuracy of information related to studying abroad for international students; the affiliated office server 300 that is operated by the institution for studying abroad and provides the study abroad candidate with information about studying abroad; and the relevant institution server 400 that shares computerized information with the affiliated office server and is linked with the affiliated office server.

Examples of the study-abroad candidate terminal 100 include on-line connectable terminals in all forms, such as general personal computers, smart phones, tablet terminals and the like. The study-abroad candidate terminal 100 is a medium for enabling the decisions regarding all procedures necessary for studying abroad through on-line connection when the study-abroad candidate finally determines an institution for studying abroad (e.g., a school targeted for studying abroad) by connecting to a relevant website via on-line connection and by searching and confirming information about studying abroad. Here, the website is a webpage established for providing information about studying abroad via an operating association institution operating the system for ensuring the accuracy of information related to studying abroad according to the present invention, namely, the operating association server 200, and the website will be described later.

Accordingly, the study-abroad candidate terminal performs a function for enabling the study-abroad candidate to access to the website provided by the operating association server via the study-abroad candidate terminal. In the case of an initial candidate for studying abroad, he or she can use the website as a full member after going through a process for signing up for a membership by accessing to the web via the study-abroad candidate terminal.

The operating association server 200 is a server of the institution that generally manages the operation system according to the present invention, and provides the study-abroad candidate terminal with all kinds of relevant information for supporting the procedures for studying abroad by establishing a web-page capable of providing the relevant information as previously mentioned via a virtual space, namely, online.

When candidates for studying abroad sign up for memberships, the operating association server preferentially stores relevant information and then issues each an ID so as to enable the candidates to log on and provides different kinds of information according to whether the candidates are members or nonmembers. Also, in order to store member information, the operating association server includes a separate operating association database 310 so that a user's information can be stored.

Also, the operating association server serves as a middle media for negotiating a contract having reliability in the procedures for studying abroad between the candidate for studying abroad and the institution for studying abroad targeted by the candidate. This will be descried in detail later.

Meanwhile, the operating association server further includes a certification module for ensuring the accuracy of information related to study abroad 220 which enables digital signatures of the certificate of ensuring the accuracy of information related to studying abroad regarding the procedures for studying abroad finally agreed among the candidate for studying abroad, the operating association and the affiliated office. The certification module for ensuring the accuracy of information related to study abroad 220 corresponds to a software module for simultaneously enabling execution of electronic signatures by accessing to the study-abroad candidate terminal, the operating association server and the affiliated office server using qualified codes allocated to each of them. This will be described in detail later.

Next, as the main constitutive element of the present invention, the system includes the affiliated office server 300. The affiliated office server 300 may correspond to a server of a corporate office operated and dispatched by the corresponding institution, namely, the institution for studying abroad. For example, when an affiliated office for American university A is established in Republic of Korea, a server of the affiliated office for the American university A corresponds to the affiliated office server. The affiliated office server should preferentially receive the affiliated office's own membership code issued from the operating association server in order to receive applications for studying abroad. The affiliated office server can formally receive applications of the candidates for studying abroad with the operating association only after the issuance of the affiliated office server's own membership code has been completed.

The affiliated office server 300 is driven by being linked with the relevant local institution server 400 (e.g., the server of US university A) and serves as a representative of university A. To do so, the affiliated office should receive a request resulting from the delegation of authority in order to acquire qualification from the operating association server.

Meanwhile, the affiliated office server 300 further includes an affiliated office database 310. The affiliated office database stores information of international students temporarily registered via the study-abroad candidate terminal to enable the international students to utilize the relevant information and reflect it to the procedures for studying abroad upon rendering a future final decision. Also, the affiliated office database stores information about requirements for an entrance examination, entrance formalities, school guides, the introduction of teaching staff and the like provided by the relevant institution server and provides the candidates upon connection via the study-abroad candidate terminal.

The relevant institution server 400 is a server of the institution for studying abroad and enables the operating association or the candidates for studying abroad to confirm all kinds of information about studying abroad by providing the information online upon request of the affiliated office.

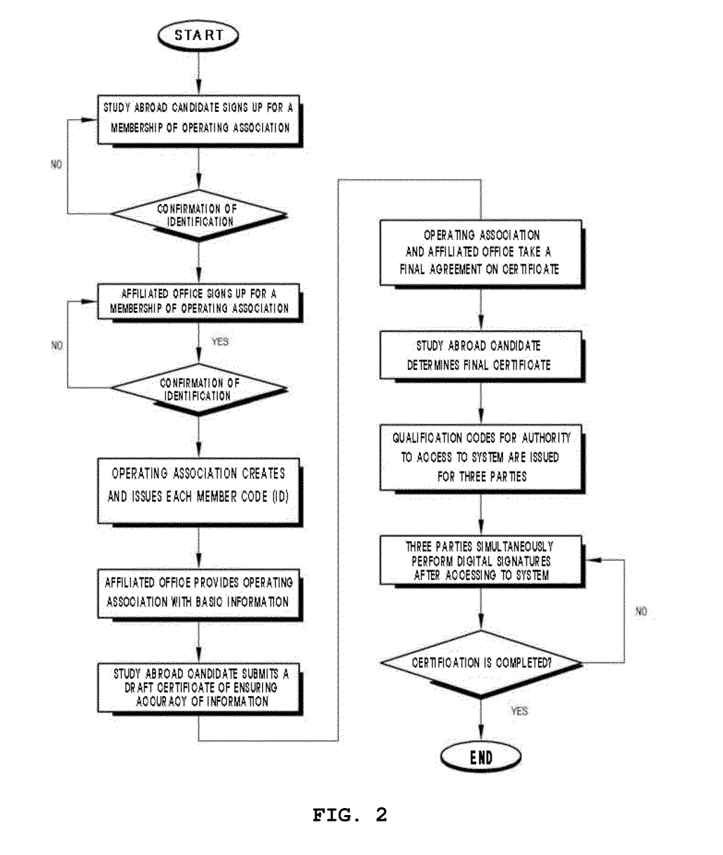

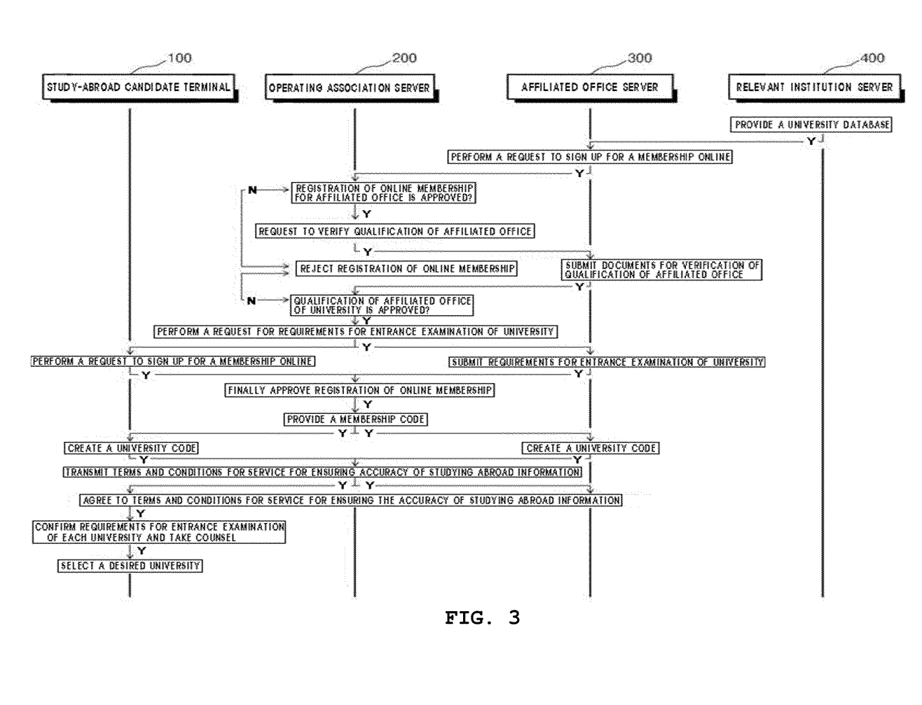

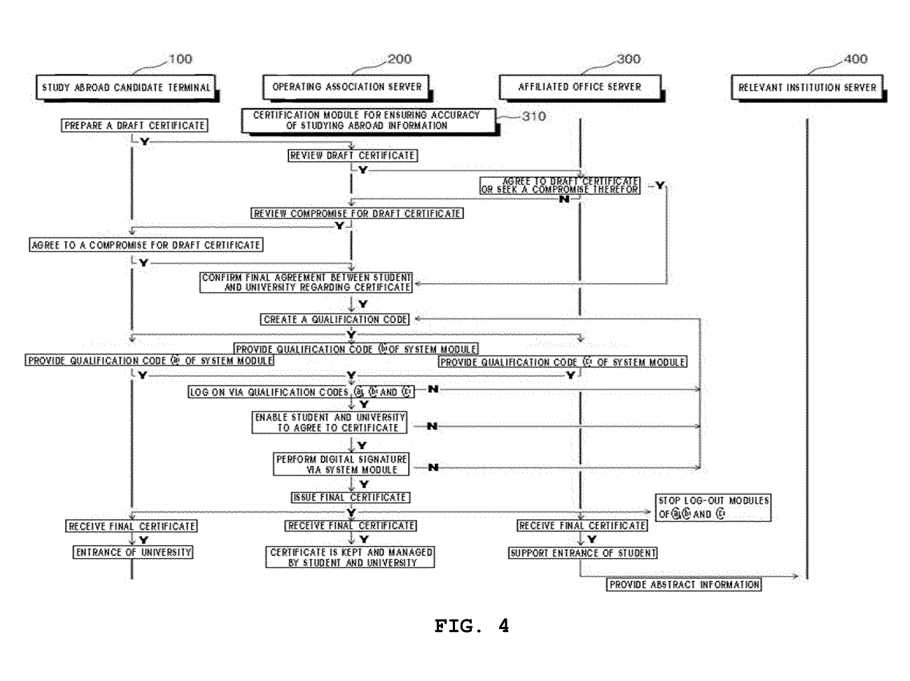

FIG. 2 is a flow chart schematically explaining procedures for ensuring the accuracy of all matters pertaining to study abroad with regard to the system for supporting study abroad-related matters of international students according to the present invention, FIG. 3 is a detailed diagram for explaining an initial cooperation process of the system for ensuring the accuracy of information related to studying abroad according to the present invention, and FIG. 4 is a diagram for showing a digital signature process for ensuring the accuracy of all matters pertaining to studying abroad with regard to the system for ensuring the accuracy of information related to studying abroad according to the present invention.

As previously described, all matters pertaining to the procedures for studying abroad are finally determined based on legal stability and high reliability, and damage resulting from other matters except for the agreed matters may be covered by the relevant institution.

The system is realized by the order clearly described below.

1. A foreign university installs an affiliated office server in the Republic of Korea and provides an affiliated office of the university with a database of the foreign university.

2. The affiliated office requests to sign up for a membership of the website of an association online.

3. Whether or not the online membership is approved is determined.

4. The operating association server requests the affiliated office server to provide the verification of qualification for a membership.

5. The approval for online membership is rejected.

6. The affiliated office server submits a document related with the verification of qualification such as a Power of Attorney regarding authority to use the database of the foreign university and the like to the operating association server.

7. The operating association server verifies the document submitted for the verification of qualification and performs the examination of qualification.

8. The operating association server requests the foreign university to provide requirements for entrance examination when the qualification is approved through the examination of qualification.

9. The affiliated office server transmits the requirements for entrance examination of the university to the operating association server.

10. The study abroad candidate submits a request for signing up for membership via the website of the association.

11. The operating association server finally approves the online memberships of the candidate and the university.

12. The association provides the candidate for studying abroad and the affiliated office server with a membership code when the approval for online membership is finally determined.

13. The membership code of the candidate for studying abroad is generated.

14. The membership code is generated in the affiliated office server.

15. The terms and conditions for the system for ensuring the accuracy of information related to studying abroad provided by the association are transmitted to the affiliated office server.

16. The study abroad candidate and the affiliated office confirm the terms and conditions for the system for ensuring the accuracy of information related to studying abroad and select agreement or non-agreement on the terms and conditions.

17. The study abroad candidate confirms the requirements for entrance examination of each school or university and receives counseling thereabout.

18. The study abroad candidate selects a desired school or university.

19. The study abroad candidate inputs a draft certificate of ensuring the accuracy of information related to studying abroad (all matters pertaining to studying abroad such as a curriculum for learning, a residence and so on) that are required by the candidate based on a form of the certificate provided by the association.

20. The association reviews the draft certificate of ensuring the accuracy of information related to studying abroad provided by the candidate for studying abroad and then transmits it to the affiliated office.

21. After reviewing the draft certificate of ensuring the accuracy of information related to studying abroad prepared by the candidate, the affiliated office agrees to the matters described in the certificate or seeks a compromise for the matters with the candidate.

22. The affiliated office prepares a draft compromise when there is a need to compromise the matters described in the certificate of ensuring the accuracy of information related to studying abroad prepared by the candidate, and transmits the draft compromise for the draft certificate of ensuring the accuracy of information related to studying abroad to the association.

23. After confirming the draft certificate of ensuring the accuracy of information related to studying abroad revised based on the draft compromise transmitted from the association, the study abroad candidate may agree thereto or may compromise it.

24. The association obtains a final agreement concerning the draft certificate of ensuring the accuracy of information related to studying abroad from the study abroad candidate and the affiliated office of the university.

25. The association creates qualification codes of the module of the system for ensuring the accuracy of information related to studying abroad with regard to the study abroad candidate and the university.

26. The association, the study abroad candidate and the university are provided with the qualification codes of the module of the system for ensuring the accuracy of information related to studying abroad.

27. The association, the study abroad candidate and the university log on simultaneously with the qualification codes.

28. Under a state of logging on simultaneously with the qualification codes, the association, the study abroad candidate and the university mutually confirm all the matters regarding studying abroad and the draft certificate of ensuring the accuracy of information related to studying abroad rendered between the study abroad candidate and the university and a security system and so on provided by the association and then agrees thereon.

29. Under a state of logging on simultaneously with the qualification code, when the association, the study abroad candidate and the university agree on the matters, an electronic signature is conducted via the module of the system for ensuring the accuracy of information related to studying abroad. If the association, the study abroad candidate and the university do not simultaneously perform the electronic signature, the module of the system for ensuring the accuracy of information related to studying abroad will not go on to the step of item No. 30 below.

30. With regard to the certification module for ensuring the accuracy of information related to studying abroad, the association, the study abroad candidate and the university should simultaneously maintain a log on status, and when one of them is in a log out status, the module for ensuring the accuracy of information related to studying abroad is stopped.

31. When the association, the study abroad candidate and the university complete digital signatures in a state of simultaneously logging on with their qualification codes, the certificate of ensuring the accuracy of information related to studying abroad is finally issued via the module of the system for ensuring the accuracy of information related to studying abroad s.

32. The association, the study abroad candidate and the university receive the certificate of ensuring the accuracy of information related to studying abroad from the module of the system for ensuring the accuracy of information related to studying abroad s.

33. When the certificate of ensuring the accuracy of information related to studying abroad is issued, a right of the student is protected from the association and the university for the period from obtaining admission requirements for the university to the confirmation of admission pursuant to the certificate of ensuring the accuracy of information related to studying abroad.

34. When a confirmation document of the association is issued, the association begins to support and manage a process to enter the university and official affairs for studying abroad and to manage rights of the student and the university based on a post proposal for studying abroad.

35. When the confirmation document of the association is issued, the university takes responsibility for all matters pertaining to admission of the student, supports the student for the study abroad-related matters such as the life of studying abroad and the process of admission and provides and manages a life environment of studying abroad pursuant to the certificate of ensuring the accuracy of information related to studying abroad.

As such, the steps of ensuring the accuracy of information related to studying abroad for the study abroad candidate performed with regard to the institution have been described in detail.

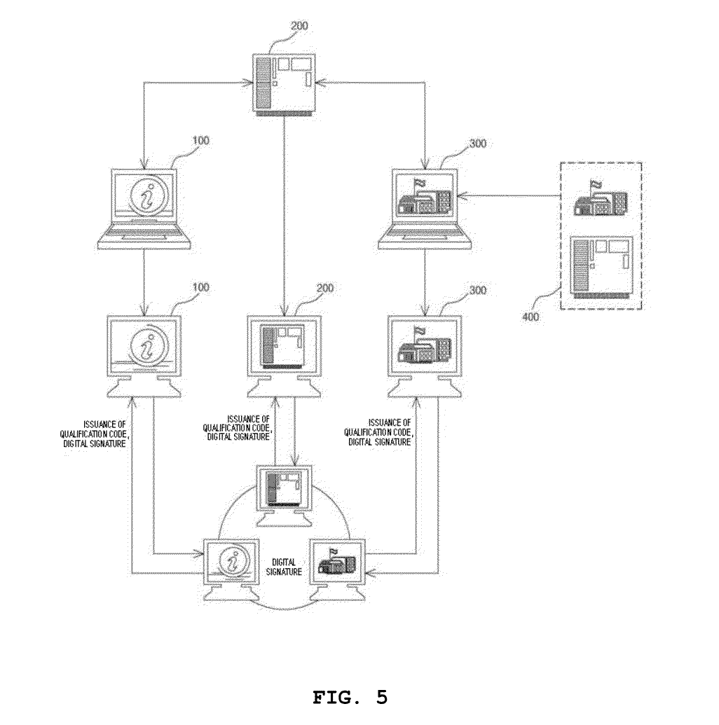

Among these steps, the digital signatures intended for the agreement among three parties regarding ensuring the accuracy of information related to studying abroad will be further described with reference to FIG. 5.

FIG. 5 is a block diagram showing the operational status of a study abroad-related matter ensuring certification module for digital signatures according to the present invention.

As illustrated in FIG. 5, the certification module for ensuring the accuracy of information related to study abroad 220 enables the study abroad candidate, the association and the university to digitally sign the certificate of ensuring the accuracy of information related to studying abroad in a state of being simultaneously connected to the study abroad candidate terminal, the operating association server and the affiliated office server with the allocated qualification codes by driving the certification module for ensuring the accuracy of information related to studying abroad managed by the operating association server, and all the contents indicated in the certificate of ensuring the accuracy of information related to studying abroad must be performed.

The present invention configured as described above is advantageous in that various existing problems such as injustice, irrationality, economic loss, improper management and so on generated during preparing for studying abroad or a overseas life of candidates for studying abroad by finally determining a certificate of ensuring the accuracy of information related to studying abroad utilized as clear basis data between a candidate for studying abroad and an institution for studying abroad with digital signatures via a sufficient agreement between the interested parties.

Although the preferred embodiments of the present invention has been described for illustrative purposes with reference to the drawings, the present invention should not be limited to the drawings and the configurations and operations described. Rather, those skilled in the art will appreciate that various modifications, additions and substitutions are possible, without departing from the scope and spirit of the invention as disclosed in the accompanying claims. Accordingly, it should be regarded that appropriate all changes and modifications, and equivalents thereof fall within the scope of the present invention.

What is claimed is:

1. A system for ensuring the accuracy of information related to studying abroad of international students, comprising:
a study-abroad candidate terminal that enables a study abroad candidate to proceed with a process to sign up for a membership by accessing the internet and to provide his or her own information necessary for studying abroad or to receive external information on studying abroad online so that the study abroad candidate can ask for admission or can determine whether or not to study abroad;
an operating association server that is operated by an operating association in the study abroad candidate's native land corresponding to an association for generally operating the procedure for studying abroad, wherein the operating association server receives member information provided via the study-abroad candidate terminal for enabling the study abroad candidate to perform the process of signing up for a membership and requests official information necessary for studying abroad to receive the corresponding official information;
an affiliated office server that is operated and managed by an institution for studying abroad in a foreign country determined by the study abroad candidate as the institution targeted for studying abroad, wherein the affiliated office server provides the operating association server with information necessary for the procedure for studying abroad received from the corresponding institution, enables a database to be shared so that the information can be provided to the study abroad candidate who requests the admission for studying abroad, and receives official information on the procedures for studying abroad of the study abroad candidate provided from the operating association server; and
a relevant institution server that is linked with the affiliated office server and is operated by the institution for studying abroad in the foreign country targeted by the study abroad candidate,
wherein the relevant institution server provides the affiliated office server with all official information pertaining to the procedures for studying abroad and finally receives and manages all official information pertaining to studying abroad provided with the study abroad candidate,
wherein the operating association server provides the study abroad candidate terminal with the form of a certificate of ensuring the accuracy of information related to studying abroad to receive a draft certificate of ensuring the accuracy of information related to study abroad from the study abroad candidate, and
wherein the operating association server, which has received the draft certificate, determines as to whether or not to agree to the draft certificate by receiving a compromise for the draft certificate from the affiliated office server and issues qualification codes for enabling accessing to a certification module provided via online and for validating the final certificate of ensuring the accuracy of information related to studying abroad which have been finally determined through the agreement,
whereby the respective qualification codes can be allocated to the study-abroad candidate terminal, and the study abroad candidate, the association and the university can simultaneously perform digital signatures via the study-abroad candidate terminal, the operating association server and the affiliated office server in a state of being simultaneously connected to the certification module via the respective qualification codes, thereby proceeding with approval of the procedure for studying abroad.

2. The system of claim 1, wherein the study-abroad candidate terminal enables the study abroad candidate to perform a process for signing up for a membership of the association when the study abroad candidate is not registered in the operating association server as a member.

3. The system of claim 1, wherein the affiliated office server requests the operating association server to perform a request for the verification of qualification so that the study abroad candidate can obtain the verification of qualification, and official affaires for studying abroad can be performed upon completing of the verification of qualification via the affiliated office server.

4. The system of claim 1, wherein the certificate of ensuring the accuracy of information related to studying abroad comprises all kinds of information about studying abroad and may be intended to ensure study abroad-related matters including a curriculum for learning, a living condition (dormitory, lease or the like), living information of students and so on.

5. The system of claim 1, wherein the affiliated office server shares a database by being linked with the relevant institution server, wherein the affiliated office server provides the operating association server with information about requirements for entrance examination which will be basically provided to the study abroad candidate and also provides the information about the requirements for entrance examination when the study abroad candidate performs a search for study abroad-related information by accessing to the study-abroad candidate terminal.

6. The system of claim 1, wherein the operating association server issues a membership code for the affiliated office when a request for membership qualification is received from the affiliated office server and the affiliated office is determined as a member.

7. The system of claim 1, wherein the operating association server issues the final certificate of ensuring the accuracy of information related to studying abroad with the digital signatures when the digital signatures performed via the study-abroad candidate terminal, the operating association server and the affiliated office server are completed, stores it in an operating association database, and transmits it to the study abroad candidate via e-mail.

8. The system of claim 1, wherein the operating association server comprises an operating association database in which information about the study abroad candidate registered as a member via the study-abroad candidate terminal and information about the institution for studying abroad registered a member via the affiliated office server are stored.

9. The system of claim 1, wherein the affiliated office server further comprises an affiliated office database in which the certificate of ensuring the accuracy of information related to studying abroad of the corresponding study abroad candidate issued by the digital signatures of the system for ensuring the accuracy of information related to studying abroad via the study-abroad candidate terminal, the operating association server, and the affiliated office server, and information about the study abroad candidate received from the operating association server are stored, and which is provided to the relevant institution server.
